(19) United States
(12) Patent Application Publication
(10) Pub. No.: US 2002/0169851 A1
(43) Pub. Date: Nov. 14, 2002

(54) Internet-based system for dynamically creating and delivering customized content within remote web pages

(76) Inventors: Robert Weathersby, Rye, NH (US); Robert Mancarella, Portsmouth, NH (US); Sambasiva Nadella, Woburn, MA (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/969,812

(22) Filed: Oct. 4, 2001

Related U.S. Application Data
(60) Provisional application No. 60/237,385, filed on Oct. 4, 2000.

(51) Int. Cl. G06F 15/16

(52) U.S. Cl. 709/218; 707/501.1

(57) ABSTRACT

A method and system for providing automated web publishing using templates and use of third party network sites to dynamically communicate information to a hosting application and to receive custom content based on a call to the hosting application for publishing the content at a publishing location relevant to the content. The system includes three tiers of architecture, including 1) presentation logic to capture, organize, and publish content at the third party site and to provide for administration of the site; 2) business logic for handling information requests via a server on the network providing information to the third party site; and 3) persistent storage using, for example, relational databases or other repositories to support functionality.

This application claims priority from U.S. Provisional Application Serial No. 60/237,385 filed Oct. 4, 2000, of Robert G. Weathersby, et al., titled “INTERNET-BASED SYSTEM FOR DYNAMICALLY CREATING AND DELIVERING CUSTOMIZED CONTENT WITHIN REMOTE WEB PAGES.” The entirety of that provisional application is incorporated herein by reference.

### BACKGROUND OF THE INVENTION

1. Field of the Invention

The present invention relates to web publishing and use of Extensible Style sheet Language (XSL) and Extensible Server Page (XSP) capabilities to create Extensible Markup Language (XML) template for translation into customized HyperText Markup Language (HTML) code, and in particular to a product that allows third party web sites to dynamically communicate with a hosting application and receive back customized content based on the call.

2. Related Art

U.S. Pat. No. 6,029,141 to Bezos et al.

www.yo.com as viewed on Sep. 27, 2001.

### BACKGROUND OF THE TECHNOLOGY

Many web sites include specialized services for their users. These services are often third party products. Utilizing these products while allowing the site to evolve its look and feel autonomously requires a connection between parties that is loosely coupled.

Other solutions to this problem have used “redirect” Universal Resource Locators (URLS), wherein the third party's end user is transferred to the service provider's site, in effect forcing the third party to lose contact with the user (see e.g., U.S. Pat. No. 6,029,141). Additionally, this approach requires the service provider to create and maintain web pages that look and feel like the third party's, in effect having to mimic the third party site on an ongoing basis (creating a legacy/maintenance burden on both client and service provider).

Documents can be created in XML as “masters” that can be translated via XSL into HTML code that incorporates the look and feel of a current web page—a “publish once” paradigm that is well known (although fairly recent). However this process is typically used to republish a complete page of content or as an efficiency method to store/archive a master document that can be republished in a number of different manifestations (e.g., type styles, point sizes).

Similarly, use of XSP is well documented for publication tasks (although also fairly recent).

The combination of an XML master translated via XSL into custom HTML according to logic incorporated within XSP may be not be novel in that each step is specifically anticipated and designed into their functionality. However, it is not known to the use these components to create dynamic content (based upon a data feed from a client) that is published back as an element(s) on a client web page within defined “reserve spaces” when it is rendered for the viewer.

### SUMMARY OF THE INVENTION

The present invention overcomes the limitations of the prior art in that content is served up to a user as integral part of the client site (as opposed, for example, to hypertext links to a master catalogue that require the user to migrate outside of current session - no new session/window is spawned). The present invention differs from publication methods of the prior art in use of “reserved areas”—once these are defined at the client site (along with client HTML parameters incorporated into XSL) during installation, the client is free to change web site (in that data feed to the present invention, referred to as “efavorites” includes destination and placement information for return of custom content), creating much more flexibility than the “hard coded” solutions of the prior art.

The combination of system components of the present invention, such as application servers, Enterprise Java Beans, back end databases, and leading edge XML/XSL publishing technology, creates a powerful blend. The total solution is a high performance enterprise-ready system, which can handle the highest of loads, but is also highly configurable.

The efavorites technology can be used to deliver powerful and engaging content into existing web sites. It is also offers a flexible, highly modular, solution. The efavorites architecture is designed to grow while delivering enterprise class performance. It easily supports further customization to constantly evolve user experiences and meet business requirements.

The present invention is logically divided into three components: 1) third party site web pages that include “reserved spaces” or tagged publishing locations; 2) communication medium; and 3) service provider site software. The three components work in concert to provide dynamically generated customized content incorporated into (and with the same look and feel as) the client web page as it is displayed/rendered by client for the end-user.

On the third party site, the product “services” are “reserved space(s)” or publishing locations defined as HTML tables within a client web page(s). Associated with the tables is a predefined HTML “tag”. At runtime the tags call the publishing engine. The publishing engine invokes proprietary business logic to generate content-specific, customized content for the reserved spaces within the third party site. This HTML content is delivered to the third party site in real time as the page is about to display/render to the viewer. The delivery and display is totally seamless to the end user. XML, XSL, and XSP are used to facilitate this process/system, increasing flexibility in the ability to have a standard logic set that can be expressed as customer HTML at the user site. By defining “reserved spaces” within tagged (and therefore variable) web pages/addresses, the resultant custom content can be rendered in the client's “look and feel” in real time at any location specified by the client (whether it is the initial web page address at time of installation of the efavorites system or, if client subsequently changes their web site, the relevant location specified by the client on a new web page).

The invention works with a minimum of “touch points” at the client site (e.g., the HTML tags, the data stream and the reserved spaces), making installation simple and allowing for subsequent changes at the client site without the loss of efavorites functionality or the cost of modifying a “static” publishing application.

In one embodiment, the invention operates via a network, such as the Internet (e.g., in a hosted or Application Service Provider (ASP) fashion). In another embodiment, the invention operates internally within a company or other user's environment, including, for example, an intranet. The software at user sites may be installed remotely via a network, such as the Internet, or it may wholly operate from a remote location, such as from a server on the network using software, such as applets. The server includes, for example, a personal computer (PC), a minicomputer, a microcomputer, or a main frame computer

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 presents a pictogram of system components, in accordance with an embodiment of the present invention;

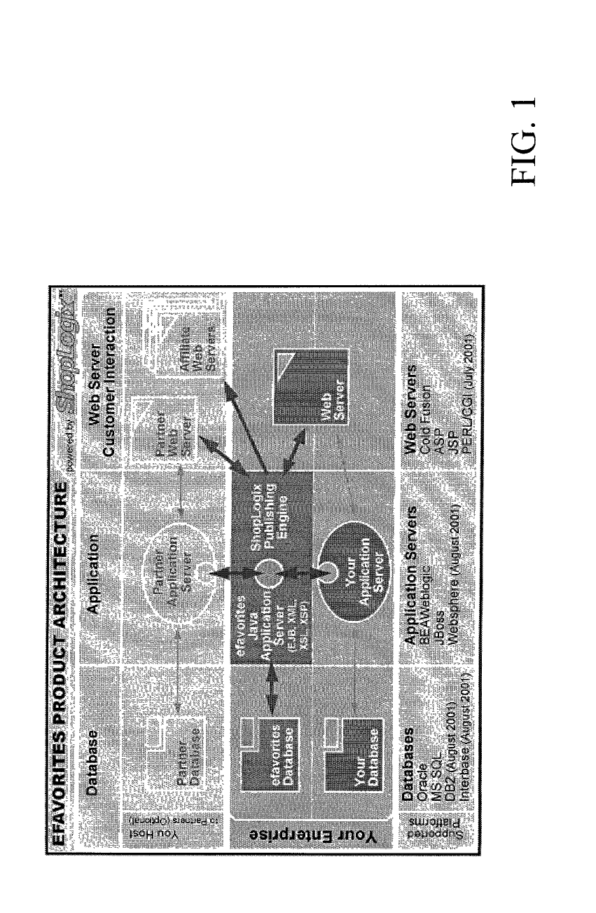

FIG. 2 shows an example graphical use interface (GUI) screen, in accordance with an embodiment of the present invention;

FIG. 3 is a system components diagram, in accordance with an embodiment of the present invention; and

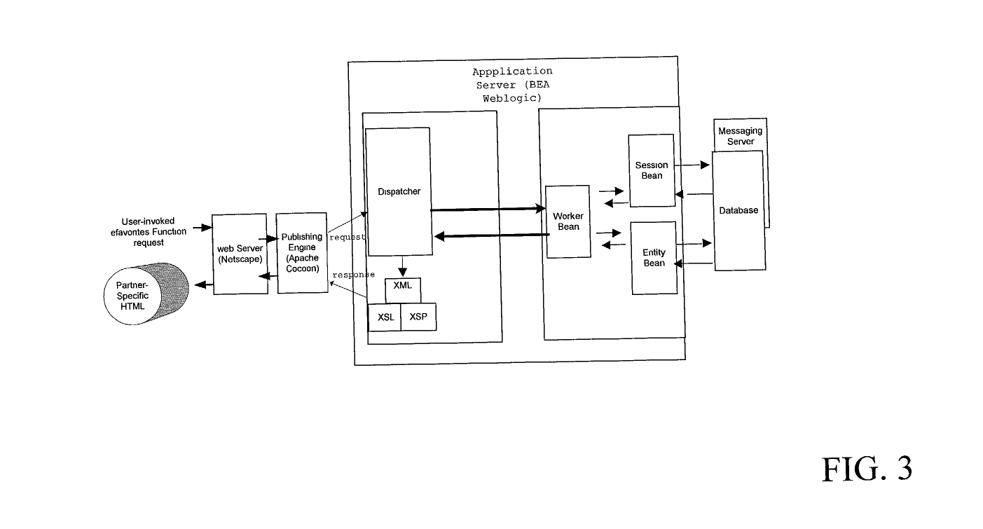

FIG. 4 contains a flow diagram of a method of operation, in accordance with an embodiment of the present invention.

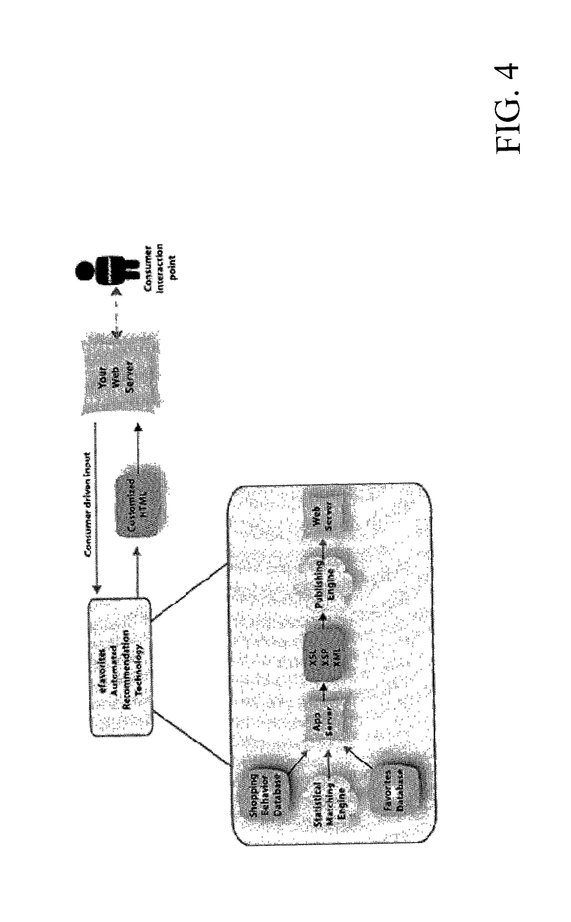

### DETAILED DESCRIPTION

The present invention includes an Internet-based system involving a multi-tier architecture for creating context sensitive customized HTML-content and delivering this content as a seamless part of third party web pages via a web publishing framework. The system defines “reserved areas” within a third party web page into which customized HTML-content is published. A data structure feed from the third party includes sufficient elements to allow efavorites to create customized content that is context sensitive. The data feed is used to dynamically create XML content according to logic rules incorporated within an XSP. The XML content is processed via an XSL into HTML code that is consistent with the “look and feel” of the third party web page (same font, point size, color scheme, etc.). The resultant HTML code is delivered back to the third party web page “reserved area” and displayed to the user when the third party web page is displayed (giving the appearance that the entire page is delivered instantaneously from the third party). Multiple reserved areas within a single third party web page can be dynamically populated with the appropriate (e.g., context sensitive) HTML code using this system.

The present invention is logically divided into three components: 1) third party site web pages that include “reserved spaces” or tagged publishing locations; 2) communication medium; and 3) service provider site software. The three components work in concert to provide dynamically generated customized content incorporated into (and with the same look and feel as) the client web page as it is displayed/rendered by client for the end-user.

On the third party site, the product “services” are provided publishing locations defined as HTML tables. The table definition on the partner web page includes HTML “tags”. The tags invoke proprietary logic. This logic invokes a dynamic call to the main site as the page is about to be displayed. The call's parameters identify the partner, action (web page about to be displayed) and user (if appropriate). The logic also includes error handling constructs.

The parameterized call invokes a proprietary HTTP communications call. The call is written, for example, in either Java or C++ (COM), depending on platform. This call is responsible for passing data to and from the main site and the third party site. Within the main site, proprietary logic receives and parses the call. Additional proprietary logic invokes business rules, retrieves data from the relational database, and passes it off to the web publishing engine. The publishing engine assembles business logic (invoked via an Extensible Logic Sheet “XSP”), content (represented in a proprietary XML schema), and presentation (represented in a proprietary Extensible Style Sheet “XSL”), and outputs customer specific HTML. The HTML is passed back to the third party as a return result through the communications call.

Completing the scenario, the customer-specific HTML is assigned to the third party site web page's HTML table, and displayed as a seamless entity to the end user in a publishing location relevant to the identified data.

The efavorites product is designed as to empower rich, dynamic user generated content and compelling user experiences for existing web sites. The system provides: 1) high performance; 2) high scalability; 3) easy, multi-platform implementation; 4) rich dynamic content; 5) multiple, simultaneous participating sites, related or un-related; 6) simple, modular features and expansion; and 7) remote accessibility.

To meet these goals, the present invention uses a three tier architecture comprising server and client side Presentation Logic, Java based Business Logic, and Persistent Storage.

### Tier I: Presentation Logic

Efavorites functionality is designed to be viewed and accessed using browser technologies. Efavorites technology is used to capture, organize, and publish content to enrich existing web sites. It is also used to create a powerful site administrators web site (the efavorites Admin Tool) where site content is evaluated and administered.

At the presentation level, content is requested, formatted, and presented using the following technologies: 1) lightweight tags embedded in front-end web pages (JSP, Active Server Page (ASP), Cold Fusion, or Sample Object Access Protocol (SOAP)) to make server requests; 2) server-side XML (XSP) pages for collecting and collating data; 3) server-side XSL pages for transforming XML data into formatted HTML; and 4) client-side cascading style sheets (.CSS) for controlling font, color, and other presentation elements.

1. Client-Side Tags

Efavorites functionality was originally designed to operate in an application service provider environment. It was assumed that it would involve integrating functionality into a variety of web sites that could be inter-related or unrelated. These sites would be developed using a variety of technologies. Furthermore, it was anticipated that all of these disparate clients would be making request to a central, clustered, application server that would be servicing these requests.

To make this possible, the present invention includes a lightweight tag set for each of the supported client environments that provides an API for making requests to the application server, and then publishing the results.

Collectively, these client-side packages are referred to as tags. Though the technology will differ, to accommodate easy integration into existing sites, the functionality of these tags is consistent. Each tag set is a series of simple APIs that can be called. Each tag creates a parameterized URL that it sends to the (potentially remote) application server. The tag then catches and publishes the response to a container space on the site.

The present invention includes tag sets for the following platforms: 1) Custom Cold Fusion tags (.cfm) for sites developed with Cold Fusion; 2) Java classes for sited developed using .jsp; 3) Active Server Page functions for sites developed in ASP; 4) SOAP (Simple Object Access Protocol) calls to deliver functionality and content to CGI/PERL sites.

For example, one of the tags may be called to get the set of recommendations written about a restaurant. The call to this tag, made from the site's item page looks like:

<tr>

<td><CF_EF_GetProductRecommendations

select_session_id=“#session_id#”></td>

</tr>

The Cold Fusion implementation of this tag looks like:

CFPARAM Name=“Attributes.select_session_id”>

<CF_EF_PrepForPopup text=#session.ef_product_name#>

<CFIF isDefined(“url.efav_disp”)>

<CFSET efav_disp=#url.efav_disp#>

<CFELSE>

<CFSET efav_disp “PP”>

</CFIF>

<CFSET inputvars=“?form=productrecomm&client_id=” &

#session.ef_client_id# &

“&client_member_id=” & #session.ef_member_id# &

“&product_number=” & #session.ef_product_number# &

“&machine_id=” & #session.ef_machine_id# &

“&product_name=” & #scrubbed_text# &

“&client_category_num=” & #session.ef_client_category_num# &

“&product_std_num=” & #session.ef_product_std_num# &

“&efav_disp=” & #efav_disp# &

“&select_session_id=” & #Attributes.select_session_id#

>

<CF_Ef_GetData urlArgs=#inputvars#>

The CF_Ef_GetData tag makes CFHTTP call with the parameterized URL, to send the request to the server.

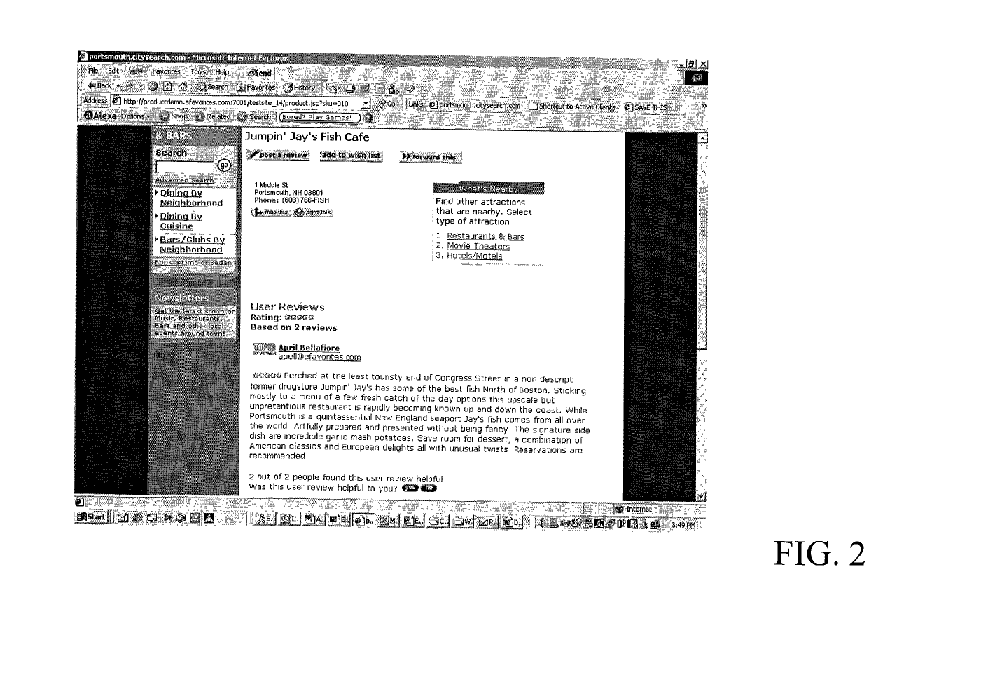

The result of the call for this example is illustrated in FIG. 2. The tag model allows very lightweight, modular implementations. On the client site, all that is required is access to these tags that make calls to the server. The call to the tag can be placed anywhere within an existing page where the functionality is desired. The functionality can be enabled or disabled by simply adding or removing the tag calls. New or modified functionality and tags can be added at any time.

2. Sever-side XML (XSP)

Once the application server receives the request, it is forward to the appropriate XSP page. XSP (eXtensible Server Pages) is a technology developed as part of the Apache Cocoon publishing framework. The XSP format allows for a mixture of Java logic and XML results. The Java code makes calls to the server's Enterprise Java Beans where the data is accessed and gathered. Those results are turned in the XML to establish the association between the data elements. The XML data is then handed over to the XSL stylesheet for conversion to HTML.

3. Sever-side XSL

The second part of the Cocoon framework is the conversion of the XML data into publishable HTML using the XSL (eXstensible stylesheet language) stylesheet. The XSL maps the XML data elements into HTML, adding additional (sometimes client-specific) logic and presentation elements as required, and prepares the data for publication, before it is sent back to the client server.

4. Client-side Cascading Style Sheets

As the last step before publication, formatting tags within the HTML that determine presentation elements, such as colors and fonts, are associated with the Cascading Style Sheet (CSS). These style elements are applied just prior to publication.

### Presentation Layer Summary

A number of steps and technologies go into the presentation logic. The integration of these technologies gives the functionality ease of implementation and a powerful decoupling of business and presentation logic. This gives the present invention maximum flexibility for rapid, flexible customization of the look and feel of the functionality provided, rapid addition, modification, or removal of functionalities, and allows for simple and seamless integration with existing site content.

### Tier II. Business Logic

The server-side business logic is handled using Java servlets Enterprise Java Beans (EJBs) so that highly customizable, high performance, highly scalable solutions can be offered. The key elements of the business logic are: 1) Java servlets for handling server requests; 2) Enterprise Java Beans which access the database and hold most of the business logic; 3) Database Stored Procedures; and 4) J2EE Application Servers that provide the platform and context for the servlets and EJBs.

1. Java Servlets

Java servlets handle the requests to the application server, provide a level of security and validation, and then pass the request through to the appropriate XML form, EJB, or Java class.

2. Enterprise Java Beans

Enterprise Java Beans are used to manage t he complex business logic. Application state and database access are managed using entity beans. Complex business logic and algorithms are implemented within session beans.

3. Database Stored Procedures

Structured Query Language (SQL) stored procedures are used for rapid database access for data analysis in overnight batch scripts and on-the-fly data requests.

4. Application Servers

J2EE Java application servers provide the backbone and platform for the servlet and Enterprise Java Beans. The pure-Java solution allows the present invention to run on and support multiple applications servers, and easily port to new servers. The efavorites functionality is available, for example, through BEA's Weblogic and Jboss open source application server.

### Business Logic Tier Summary

The use of leading-edge, highly scaleable technologies allows the present invention to maintain a high level of performance, to provide sophisticated analytics, and to rapidly deliver content, even in a high-activity, heavy load environment. The business logic of the present invention is highly modular, very expandable, high performance, and highly scaleable. As system load increases, additional application servers can be added to spread the workload. Additionally, application server clustering can provide for a highly reliable, fault tolerant, 100% uptime system.

### Tier 3: Persistent Storage

The persistent storage of the present invention is handled through the use of relational databases. One embodiment includes its own database schema to support functionality, and to support further data analysis and reporting. The efavorites database is accessed through the Enterprise Beans and can be separate and distinct from existing databases and data warehouses. This facilitates rapid implementation and integration, and it also allows for data, and therefore content, sharing across disparate sites and multiple systems.

The following relational databases, for example, are supported: 1) Oracle; and 2) SQLServer.

### Architecture Overview

The efavorites architecture utilizes leading edge technologies (Java, EJB, XML, XSL, SOAP) to deliver rich content into existing web sites. Lightweight tags on the client side access the high-performance back end server. This provides a solution that is: 1) high performance; 2) highly scalable; 3) easy to implement; 4) Modular; and 5) Remotely accessible

Efavorites functionality is loosely coupled to the partner site, allowing each partner to perform routine page maintenance without disruption to efavorites delivery or requiring intervention. Each efavorites component creates a request, and transfers it via HTTP to the server, which responses with fully formatted HTML. No XML components need to be installed on the partner site.

### Features Guide

### Add a Recommendation

From the partner's detail page the member can click on the link “write a recommendation”. This opens a JavaScript Pop-up window. This service allows the member to rate and write a recommendation of the product, service, restaurant, etc.

### Add to Wish List

From the detail page, the member clicks on “add to my wish list”. This opens a Java Script Pop-up window. This service allows the member to add a product to his or her wish list on their homepage.

### Forward a Recommendation

From the detail page the member can click the URL “Forward to afriend” to open a JavaScript pop-up window where the member can send an e-mail message containing the URL of the product and comments entered by the member.

### Forward Wish List

From the member's home page the member can click the URL “Forward my Wish List” to open a JavaScript pop-up window where the member can send an e-mail message containing the URL of the member's wish list and comments entered by the member.

### Edit/Delete Recommendations

A member selects “my page”. From this page the member can edit or delete their recommendations.

Edit—The member clicks on the edit URL of any of the recommendation, this will bring up the “edit a recommendation” pop-up in edit mode.

Delete—If the member wants to delete a recommendation they can check the box “markfor delete” and the recommendation will be deleted from the list.

### Add Favorite People

This service allows the member to make the author of a recommendation a favorite person.

Clicking on the author's name URL will bring up to the author's page. Click “add to my favorite people” to add the author to the favorite people list. The links on the favorite people list can be followed to read their recommendations and wish list selections.

### Join Group

From the member's home page the member can click the URL “Join Groups” to see a list of special interest groups set up by the efavorites partner.

### My Profile

From the user's “my page” the member clicks the “edit my profile” URL link. This opens a JavaScript Pop-up window that will allow a valid member to enter text describing him or herself for others to view, along with the ability to make their email visible to other members.

### Helpful Votes

Users are presented with the option to indicate whether they found a recommendation helpful or not helpful. The number of helpful votes and number of total votes that a recommendation has received are displayed with the recommendation.

### Member Activity

This service displays an outline of the member's recommendation activity on a member or other's page. Details include reviewer rank, number of recommendations made, and number of helpful votes received.

Reviewer rank is determined nightly for each efavorites partner. Rank is determined by a formula based on number of recommendations, the number of times a member was selected as a favorite person, number of helpful votes received, and number of not helpful votes received. The efavorites partner may easily modify this formula.

### Related Selections

This portion provides a passive service that provides the member with a list of related products based on the patterns of products that other users have selected (added to their shopping carts).

From a product page, users can be presented with links to other products that were selected by the people who selected this product.

From a member home page, users can view a list of other products that were selected by people who selected the same products they did.

### Related Recommendations

A passive service that provides the member with a list of related recommendations based on the patterns of recommendations that other users have written.

From a detail page, users can be presented with links to other products that are recommended by people who recommend the current product.

From a member home page, users can be presented with a list of recommendations made by people who recommended the same products they did.

### Group Recommendations

A passive service that provides the member with a list of products most often recommended by members of a particular special interest group.

### Join/Register

This is a service that is activated when a non-registered user writes a recommendation, signs up, or logs on to the host site.

### People Search

From the users “my page” or “other's page” the member can search for members they know, to see their recommendations or wish list by using either name or email address. Once the search results are returned, if the member clicks on a member's name URL link, this will bring them to the page containing that member's recommendations and wish list.

### Enticement (Lottery)

This service provides a link the members can follow to enter a lottery to win a prize offered by that partner. The software checks to see if the user meets certain criteria, such as writing a specified number of recommendations, and sends the user to an appropriate information page.

### Featured Members/Experts

This is the ability to feature reviewers or site experts on splash or category pages, providing easy access for site visitors to the featured individuals' reviews and recommendations.

### Associated Products

This functionality allows site administrators to create explicit links and associations between different product pages. When a designated administrator logs into the site, functionality for creating links between products become available. Once the associations are established, the links to associated products appear on product pages

### Experts List

This is a list of all the designated exerts on the site with links to their Experts pages.

### Members Home Page

The member clicks “my page” link. This is a template that is available to allow the member to view their Homepage. This is a consolidated place to see their recommendations, wish list, favorite people, and products and promotions that match their interest.

### Others Home Page

The member clicks another member's name on one of their recommendations, or in the results of a people search. This takes the user to an “others page” template, which displays another member's recommendations, wish list, favorite people, and personal information.

### Experts Home Page

The Expert's Home page is a variation on the Other's page that also can include a picture of the expert and list of links to other experts.

(Note: The JavaScript Pop-up windows and Template pages are supplemented with partner-specific icons, etc., for publishing to partners in a look and feel consistent with their site.)

### Integration

### Steps

1. Efavorites provides a set of images, cascading style sheets (.css) and JavaScript source files (.js). It also provides the user with a unique client identification number (client_id). The client copies these source files into a folder named efav/<client_id>in their web site root directory. For example, if your efavorites-supplied ID number is 1000, this directory will be efav/1000.

2. Efavorites will provide a set of page templates and include files. These files are placed in the client's website root directory. An efavorites integration engineer works with the client's website engineer to adapt the efavorites templates to the site, and to insert efavorites “tags” into existing pages on the website.

3. The client can provide efavorites with a list of client profile data relating to their particular website. Efavorites will use this data to set up the client's profile in a database. The specifics of this profile are provided by efavorites. It includes details such as the URLs to site home and login, and other pages, and other site defaults.

4. The client provides efavorites with a list of all of the categories and category numbers so that efavorites can establish the taxonomy for the site and get the categories into the efavorites database.

5. The client, working with efavorites integration engineers, incorporates the efavorites template pages and tag calls into their web site.

### PERL/CGI Integration

### Sample Tag

For CGI/PERL sites, calls to the application server are made using SOAP. SOAP is a lightweight protocol for exchange of information in a decentralized, distributed environment. It is used to package object requests into XML, and then transfer those requests via HTTP.

For example, one of the efavorites tags is called to publish links to related items (e.g., product, restaurant, location) on the current page. Which links get published is determined by analyzing which items are recommended by people who also recommend the current item. To invoke this functionality, a SOAP call to the application server is integrated into the item's detail PERL detail page. The SOAP call that makes the request to the server looks like:

####################Start efavorites Data Call: ################
my $var1 = SOAP::Data->type(‘long’)->name(‘session_id’)->value($session_id);
$h= SOAP::Lite
-> uri(‘urn:efavsoap:ProductFunctions’)
-> proxy($soapProxyUrl)
-> getRelatedProductRecommendations($var1);
if($h->faultcode)
{

print $h->faultcode.“”.$h->faultdetail.“”.$h->faultstring.“\n”;

}
else
{

print $h->result;

}
# # # End efavorites Data Call: # # #

Prior to making this request, the client pages would have called similar tags to provide session information, user information, and information about the current item. The server has tracked this information and associated it with this client session. When the call for the related product links is made, the server uses this information to service the request, gather the results, and publish the results.

### Template Pages

Efavorites provides PERL page templates for integration in the client web site. These are: 1) ef_mypage.pl (also referred to as Member Home Page); 2) ef_otherspage.pl; 3) ef_searchresultspage.pl; 4) ef_groupspage.pl; 5) ef_expertspage.pl; 6) ef_experstlispaget.pl; and 7) ef_groupspage.pl.

These pages already include the necessary tags for enabling efavorites functionality. They may be edited to change their look and feel, to enable or disable certain functionality, or to add links to other pages on the client's site. The efavorites tags on these pages should not require modification.

The names of these files may be changed. The fully qualified URL's to these and other pages must be provided to efavorites for inclusion in the client profile.

The client provides links to ef_mypage.pl (the member's home page) on their web site. The client does not have to provide links to the other pages. Following dynamically generated links and using efavorites functionality will automatically bring up the other pages.

Efavorites also provides several PERL templates that show the client how to add efavorites content tags to existing pages. These are: 1) DetailPage.pl; 2) SignupForm.pl and SignupDone.pl; 3) LoginForm.pl and LoginDone.pl; and 4) Cart.pl.

### Content Tag Integration

The efavorites content tags are inserted into the client's HTML pages wherever the client wants to include efavorites content. They are typically inserted into table cells.

### Custom Tags Requiring Partner Integration

These tags are added to existing web pages. Examples are provided in the efavorites-supplied Product, Signup, Login, and Cart templates.

Each tag is listed on the page it typically appears. Following the tag name is the list of parameter values the tag requires.

| Tag: Object | Remarks |
|---|---|
| Session: | |
| SessionFunctions | |
| setSessionInfo | This is call that needs to be made |
| session_id | at the start of each user session. |
| client_id | |
| machine_id | |
| ef_servlet_url | |
| ef_send_servlet_url | |
| ef_data_servlet_url | |
| Member Registration Page: | |
| SignUpFunctions | |
| sendMemberInfo | Registers a new member with |
| session_id | efavorites, or identifies |
| member_id | an existing member. This |
| e_mail | tag is used when “piggybacking” |
| first_name | efavorites registration on an |
| last_name | existing |
| | registration service. |
| | Efavorites specific Login Template |
| | pages are also available. |
| Detail Page: | |
| ProductFunctions | |
| setProductInfo | Sets product data variables. |
| session_id | Must be called prior to |
| product_name | calling any product- |
| product_number | related tags or to adding a product |
| client_category_num | to the |
| product_url | shopping cart. |
| getProductRecommendations | Publishes all the recommendations |
| session_id | written about this item. |
| getRelatedProductSelections | Publishes links to products that are |
| session_id | most commonly selected with this |
| | product. |
| getRelatedProductRecommendations | Publishes links to items that are |
| session_id | related |
| | to this one by recommendations. |
| getForwardLink | Places a link on the page that user |
| session_id | may use to send an e-mail |
| | containing a link |
| | to the item and their comments. |
| getAddRecLink | Places a link on the page that user |
| session_id | may use to write their |
| | recommendations. |
| getAddWishLink | Places a link on the page that user |
| session_id | may use to add an item |
| | to their wish list. |
| Shopping Cart Page: | |
| ProductFunctions | |
| sendShoppingCartInfo | Registers a product selection with |
| session_id | efavorites. |
| qty | setProductlnfo must be called first. |
| Other | |
| ReviewerFunctions | |
| getFeaturedExpert | Publishes information and picture |
| session_id | of a client-selected |
| feature_number | Expert on the page. |
| | Typical locations are Site Home |
| | Page, |
| | MyPage, and/or OthersPage |
| getFeaturedMember | Publishes information and picture |
| session_id | of a client-selected |
| feature_number | member on the page. |

### Tags in efavorites-Supplied Template Pages

These tags are already implemented in the efavorites-supplied template pages. The client can customize these pages by adding, deleting, or changing the order of tags.

| Tag | Remarks |
|---|---|
| Member Home Page | |
| MyPageFunctions | |
| get WhyUseEfavorites | Publishes information about |
| session_id | recommendations and a link to your |
| | signup page. |
| getMyProfile | Publishes the users bio and a link to edit |
| session_id | it. |
| getMyActivity | Publishes member activity information, |
| session_id | including reviewer rank, number of |
| | recommendations, and number of |
| | helpful votes received. |
| getMyRecommendations | Publishes the recommendations this |
| session_id | member has written. |
| getMyWishList | Publishes the products this member has |
| session_id | added to his/her wish list. |
| getMyFavPeople | Publishes a list of people this member |
| session id | has chosen as a favorite person. |
| getMyGroups | Publishes a list of the groups that a |
| session id | member has joined. |
| getLotteryLink | Places a link on the page that the user |
| session_id | may use to enter a lottery. |
| getMyRelatedSelections | Publishes a list of product selections |
| session id | made by people who selected the same |
| | products the user has selected. |
| getMyRelatedRecommendations | Publishes a list of recommendations |
| session_id | made by people who recommended the |
| | same products the user has |
| | recommended. |
| Other Member's Page | |
| OthersFunctions | |
| getOthersName | Publishes this member's first and last |
| session_id | name. |
| member_id | |
| getOthersRecommendations | Publishes the recommendations this |
| session_id | member has written. |
| member_id | |
| getOthersWishList | Publishes the products this member has |
| session_id | added to his/her wish list. |
| member_id | |
| getOthersProfile | |
| session_id | |
| member_id | Publishes this member's bio and a link |
| | to add this person as a favorite person. |
| getOthersActivity | Publishes member activity information, |
| session_id | including reviewer rank, number of |
| | recommendations, and number of |
| member_id | helpful votes received. |
| getOthersFavPeople | Publishes a list of people this member |
| session_id | has chosen as a favorite person. |
| member_id | |
| People Search Page: | |
| SearchFunctions | |
| getSearchForm | Publishes a form that allows searching |
| session_id | for other members by name or email |
| | address. |
| getSearchResults | Publishes the results of a people search. |
| session_id | |
| searchkey | |
| searchstring | |
| Groups Page: | |
| GroupsFunctions | |
| getGroupRecommendations | Publishes a list of products most |
| session_id | commonly recommended by this group. |
| group_id | |
| group_name | |
| Experts Page: | |
| ExpertsFunctions | |
| getExpertsProfile | Publishes a list of products most |
| session_id | commonly recommended by this group. |
| member_id | |
| getExpertsListBox | Publishes a list of all site experts and |
| session_id | links to their experts pages. |

### Cold Fusion Integration

### Sample Tag

For Cold Fusion sites, calls to the application server are made using custom Cold Fusion tags. Efavorites provides the tags to be copied into the client's custom tag directory. The client makes calls to these tags within their Cold Fusion pages. The tags themselves make CFHTTP calls to the efavorites application server and return formatted HTML.

Here is an example of a set of efavorites tags used on a members home page.

<TABLE>

<TR><TD><CF_EF_GetMyActivity></TD></TR>

<TR><TD><CF_EF_GetMyFavPeople></TD></TR>

<TR><TD><CF_EF_GetMyGroups></TD></TR>

<TR><TD><CF_EF_GetSearchForm></TD></TR>

</table>

Some of these tags require arguments. The arguments are described below. Most of these tags are already implemented on the efavorites-supplied Cold Fusion template pages.

### Template Pages

Efavorites provides Cold Fusion page templates for integration in the client's web site. These are: 1) ef_mypage.cfm (also referred to as Member Home Page); 2) ef_otherspage.cfm; 3) ef_searchresultspage.cfm; 4) ef_groupspage.cfm; 5) ef_expertspage.cfm; 6) ef_experstlispaget.cfm; and 7) ef_groupspage.cfin.

These pages already include the necessary tags for enabling efavorites functionality. They may be edited to change their look and feel, to enable or disable certain functionality, or to add links to other pages on the client's site. The efavorites tags on these pages should not require modification.

The names of these files may be changed. The fully qualified URL's to these and other pages must be provided to efavorites for inclusion in the client profile.

The client provides links to ef_mypage.cfm (the member's home page) on their web site. The client does not have to provide links to the other pages. Following dynamically generated links and using efavorites functionality will automatically bring up the other pages.

Efavorites also provides several Cold Fusion templates that show the client how to add efavorites content tags to their existing pages. These are: 1) DetailPage.cfm; 2) SignupForm.cfm and SignupDone.cfm; 3) LoginForm.cfm and LoginDone.cfm; and 4) Cart.cfm.

In addition, efavorites provides an include file for setting session variable values:

### EF_SiteParameters.cfm

Explanations for these files follow.

### EF_SiteParameters.cfm

The site parameters file should be included in (using the cfinclude tag) in any pages that accesses efavorites functionality. On the site parameters page, the following parameters are set with values proved by efavorites.

### ef_client_id

A value, provided by efavorites, that uniquely identifies each of the host's partners.

### ef_url

The URL that indicates the location of the efavorites servlet.

### ef_no_response_url

The URL that indicates the location of another servlet used when no response is expected from the favorites server.

### ef_port

The port for communicating with the efavorites application servers

### ef_js_url

A URL formatted for inclusion within Javascript calls.

In addition, the site parameters page is used to assign the member and machine ids. If the client is already tracking a member id that uniquely identifies the user and a machine id that uniquely identifies the machine the user is browsing from, then the client can edit this file and set the values using their current method. Otherwise, efavorites will track this information for the client and place their own cookies on the user's machine in order to track this information.

### Custom Tags Requiring Partner Implementation

These tags are designed to be added to existing web pages. Examples are provided in the efavorites-supplied Product, Signup, Login and Cart templates.

| Tag | Remarks |
|---|---|
| Product Detail Page | |
| CF_EF_SetProductInfo | Sets product data variables. |
| product_name | Must be called prior to |
| | calling any product |
| product_number | related tags or to adding a |
| client_category_num | product to the |
| product_url | shopping cart. |
| CF_EF_GetProductRecommendations | Publishes all the recommen- |
| select_session_id | dations written |
| | about this product. |
| CF_EF_GetRelatedProductSelections | Publishes products that |
| | are most commonly |
| | selected with this product. |
| CF_HF_GetRelatedProductRecommend- | Publishes products that |
| ations | are related to this |
| | one by recommendations. |
| CF_HF_GetForwardLink | Places a link on the page that |
| | user may use to send an |
| | e-mail containing a link |
| | to the product and their |
| | comments. |
| CF_HF_GetAddRecLink | Places a link on the page that |
| | user may use |
| | to write their |
| | recommendations. |
| CF_HF_GetAddWishLink | Places a link on the page that |
| | user may use to |
| | add a product to their wish |
| | list. |
| CF_HF_GetAssociationAdmin | Activates the functionality |
| | for creating lists |
| | of associated products. |
| CF_HF_GetAssociatedProducts | Get the links to products |
| | associated with the |
| | current product via explicit |
| | association. |
| Member Registration Page | |
| CF_HF_SendMemberinfo | Registers a new member with |
| member_id | efavorites. |
| e_mail | |
| first_name | |
| last_name | |
| Shopping Cart Page | |
| CF_HF_SendShoppingCartlnfo | Registers a product selection |
| qty | with efavorites. |
| select_session_id | Tag CF_HF_SetProductInfo |
| | must be called first |
| Other | |
| CF_HF_GetFeaturedHxpert | Publishes information and |
| feature_number | picture of a |
| | client-selected Expert on |
| | the page. Typical |
| | locations are Site Home Page, |
| | MyPage, and/or OthersPage |
| CF_EF_GetFeaturedMember | Publishes information and |
| feature_number picture of a | |
| | client-selected member on |
| | the page. |

### Tags in efavorites-Supplied Template Pages

These tags are already implemented in the efavorites-supplied template pages. The client can customize these pages by adding, deleting, or changing the order of tags.

| Tag | Remarks |
|---|---|
| Member Home Page | |
| CF_EF_Get WhyUseEfavorites | Publishes information about |
| | recommendations and a link |
| | to your signup page. |
| CF_EF_GetMyProfile | Publishes the users bio and a |
| | link to edit it. |
| CF_EF_GetMyActivity | Publishes member activity |
| | information, including |
| | reviewer rank, number of |
| | recommendations, and number |
| | of helpful votes received. |
| CF_EF_GetMyRecommendations | Publishes the |
| | recommendations this |
| | member has written. |
| CF_EF_GetMyWishList | Publishes the products this |
| | member has added |
| | to his/her wish list. |
| CF_EF_GetMyFavPeople | Publishes a list of |
| | people this member |
| | has chosen as a favorite person. |
| CF_EF_GetMyGroups | Publishes a list of the groups |
| | that a member has joined. |
| CF_EF_GetLotteryLink | Places a link on the page |
| | that the user may |
| | use to enter a lottery. |
| CF_EF_GetMyRelatedSelections | Publishes a list of |
| | product selections |
| CF_EF_GetMyRelatedRecommenda- | Publishes a list |
| tions | of recommendations |
| | made by people who |
| | recommended the same |
| | products the user has |
| | recommended. |
| Other Member's Page | |
| CF_EF_GetOthersName | Publishes this member's |
| member_id | first and last name. |
| CF_HF_GetOthersRecommendations | Publishes the |
| member_id | recommendations this |
| | member has written. |
| CF_HF_GetOthers WishList | Publishes the products |
| member_id | this member has |
| | added to his/her wish list. |
| CF_EF_GetOthersProfile | Publishes this member's |
| member_id | bio and a link to add |
| | this person as a favorite person. |
| CF_EF_GetOthersActivity | Publishes member activity |
| member_id | information, including |
| | reviewer rank, number of |
| | recommendations, and |
| | number of |
| | helpful votes received. |
| CF_HF_GetOthersFavPeople | Publishes a list of |
| member_id | people this member |
| | has chosen as a favorite person. |
| People Search Page | |
| CF_HF_GetSearchForm | Publishes a form that allows |
| | searching for other |
| | members by name or email |
| | address. |
| GetSearchResults | Publishes the results of a |
| ef_searchkey | people search. |
| eF_searchstring | |
| Groups Page | |
| CF_HF_GetGroupRecommendations | Publishes a list of |
| group_id | products most commonly |
| group_name | recommended by this group. |
| Experts Page | |
| CF_EF_GetExpertsProfile | Publishes a list of |
| member_id | products most commonly |
| | recommended by this group. |
| CF_EF_GetExpertsListBox | Publishes a list of all site |
| | experts and links to |
| | their experts pages. |

### JSP Integration

### Sample Tag

For JSP sites, calls to the application server are made by calling methods in client-side Java classes. These methods track session information, make calls to the application server, and publish the results back onto the page.

A sample set of method calls from the member home page looks like:

<td valign=“top” width=“100%”>

<table border=“0” cellspacing=“0” cellpadding=“0” width=“100%”>

<tr><td><%=myFuncs.getWhyUseEfavorites(session)

%></td></tr>

<tr><td><%=myFuncs.getMyRecommendations(session, efav_disp,

“mypage”,encoded_useragent) %></td></tr>

<tr><td><%=myFuncs.getMyWishList(session, efav_disp,

“mypage”,encoded_useragent) %><td></tr>

<tr><td><%=myFuncs.getMyRelatedRecommendations(session)

%></td></tr>

</table>

</td>

### Template Pages

Efavorites provides JSP page templates for integration in the client web site. These are: 1) f_mypagejsp (also referred to as Member Home Page); 2) ef_otherspagejsp; 3) ef_searchresultspagejsp; 4) ef_groupspagejsp; 5) ef_expertspagejsp; 6) ef_experstlispagetjsp; and 7) ef_groupspagejsp.

These pages already include the necessary tags for enabling efavorites functionality. They may be edited to change their look and feel, to enable or disable certain functionality, or to add links to other pages on your site. The efavorites tags on these pages should not require modification.

The names of these files may be changed. The fully qualified URL's to these and other pages must be provided to efavorites for inclusion in the client profile.

The client provides links to ef_mypagejsp (the member's home page) on their web site. The client does not have to provide links to the other pages. Following dynamically generated links and using efavorites functionality will automatically bring up the other pages.

Efavorites also provides several JSPtemplates that show the client how to add efavorites content tags to their existing pages. These are: 1) DetailPagejsp; 2) SignupForm.jsp and SignupDonejsp; 3) LoginFormjsp and LoginDonejsp; and 4) Cartj sp.

EF_SiteParametersjsp

The site parameters file should be included in (using the include file tag) in any pages that accesses efavorites functionality. On the site parameters page, the following parameters are set with values proved by efavorites:

### ef_client_id

A value, provided by efavorites, that uniquely identifies each of the host's partners.

### ef_url

The URL that indicates the location of the efavorites servlet.

### ef_no_response_url

The URL that indicates the location of another servlet used when no response is expected from the favorites server.

### ef_port

The port for communicating with the efavorites application servers

### ef_js_url

A URL formatted for inclusion within Javascript calls.

In addition, the site parameters page is used to assign the member and machine ids. If the client is already tracking a member_id that uniquely identifies the user and a machine_id that uniquely identifies the machine the user is browsing from, then the client can edit this file and set the values using their current method. Otherwise, efavorites will track this information for the client and place their own cookies on the user's machine in order to track this information.

### Content Tag Integration

The efavorites content tags are inserted into the client's HTML pages wherever the client wants to include efavorites content. They are typically inserted into table cells.

All the classes and methods referenced here are packaged in the EFJSPTagsjar which needs to included in the client's CLASSPATH.

All the classes have empty constructors. To invoke any of a classes methods, the class must first be instantiated. So, to invoke any of the methods in the ProductFunctions class the jsp would first require a line stating:

### ProductFunctions myProdFuncs=new ProductFuctions( );

### Custom Tags Requiring Partner Integration

These tags are added to existing web pages. Examples are provided in the efavorites-supplied Product, Signup, Login and Cart templates.

Each tag is listed on the page it typically appears. Following the tag name is the list of parameter values the tag requires.

Each call requires a session parameter. This is the HTTP session object intrinsic to the HTTP servlet.

| Tag Object | Remarks |
|---|---|
| Member Registration Page: | |
| SignUpFunctions | |
| sendMemberInfo | Registers a new member |
| session | with efavorites, or |
| member_id | identifies an existing member. This |
| e_mail | tag is used when “piggybacking” |
| first_name | efavorites registration on an |
| last_name | existing |
| | registration service. |
| | Efavorites specific Login Template |
| | pages are also available. |
| Detail Page: | |
| ProductFunctions | |
| setProductInfoSets | product data variables. Must be |
| session | called prior to calling any product- |
| product_name | related tags or to adding |
| product_number | a product to the |
| client_category num | shopping cart. |
| product_url | |
| getProductRecommendations | Publishes all the recommendations |
| session | written about this item. |
| getRelatectProductSelections | Publishes links to |
| session | products that are most |
| | commonly selected with |
| | this product. |
| getRelatedProductRecommendations | Publishes links to items |
| session | that are related to this |
| | one by recommendations. |
| getForwardLink | Places a link on the page that user |
| session | may use to send an e-mail |
| | containing a link |
| | to the item and their comments. |
| getAddRecLink | Places a link on the page that user |
| session | may use to write their |
| | recommendations. |
| getAddWishLink | Places a link on the page that user |
| session | may use to add an item to |
| | their wish list. |
| Shopping Cart Page: | |
| ProductFunctions | |
| sendShoppingCartInfo | Registers a product |
| session | selection with efavorites. |
| qty | setProductInfo must be called first. |
| Other | |
| ReviewerFunctions | |
| getFeaturedExpert | Publishes information and picture |
| session | of a client-selected Expert |
| | on the page. |
| feature_number | Typical locations are Site Home |
| | Page, MyPage, |
| | and/or OthersPage |
| getFeaturedMember | Publishes information and |
| session | picture of a client-selected |
| feature_number | member on the page. |

### Tags in efavorites-Supplied Template Pages

These tags are already implemented in the efavorites-supplied template pages. The client can customize these pages by adding, deleting, or changing the order of tags.

| Tag | Remarks |
|---|---|
| Member Home Page | |
| MyPageFunctions | |
| getWhyUseEfavorites | Publishes information about |
| session | recommendations and a link to |
| | your signup page. |
| getMyProfile | Publishes the users bio and a link |
| session | to edit it. |
| getMyActivity | Publishes member activity |
| session | information, including reviewer |
| | rank, number of recommendations, |
| | and number of helpful |
| | votes received. |
| getMyRecommendations | Publishes the recommendations |
| session | this member has written. |
| getMyWishList | Publishes the products this member |
| session | has added to his/her wish list. |
| getMyFavPeople | Publishes a list of people this member |
| session | has chosen as a favorite person. |
| getMyGroups | Publishes a list of the groups that a |
| session | member has joined. |
| getLotteryLink | Places a link on the page that the user |
| session | may use to enter a lottery. |
| getMyRelatedSelections | Publishes a list of product selections |
| session | made by people who selected |
| | the same products the user has |
| | selected. |
| getMyRelatedRecommendations | Publishes a list of recommendations |
| session | made by people who recommended the |
| | same products the user has |
| | recommended. |
| Other Member's Page | |
| OthersFunctions | |
| getOthersName | Publishes this member's first and last |
| session | name. |
| member_id | |
| getOthersRecommendations | Publishes the recommendations this |
| session | member has written. |
| member_Id | |
| getOthers WishList | Publishes the products this member has |
| session | added to his/her wish list. |
| member_id | |
| getOthersProfile | |
| session | |
| member_id | Publishes this member's bio and a link |
| | to add this person as a favorite person. |
| getOthersActivity | Publishes member activity information, |
| session | including reviewer rank, number of |
| member_id | recommendations, and number of |
| | helpful votes received. |
| getOthersFavPeople | Publishes a list of people this member |
| session | has chosen as a favorite person. |
| member_id | |
| People Search Page: | |
| SearchFunctions | |
| getSearchForm | Publishes a form that allows searching |
| session | for other members by name or email |
| | address. |
| getSearchResults | Publishes the results of a people search. |
| session | |
| searchkey | |
| searchstring | |
| Groups Page: | |
| GroupsFunctions | |
| getGroupRecommendations | Publishes a list of products most |
| session | commonly recommended by this group. |
| group_id | |
| group name | |
| Experts Page: | |
| ExpertsFunctions | |
| getExpertsProfile | Publishes a list of products most |
| session | commonly recommended by this group. |
| member_id | |
| getExpertsListBox | Publishes a list of all site experts and |
| session | links to their experts pages. |

### ASP Integration

1. Install the efavorites Files Onto Your Web Server

The client receives a set of files via floppy disc or other method of delivery. The client does the following.

1. Copy the efav directory into the client's website root directory (e.g., C:\Inetpubs\wwwroot).

2. Copy the files from the templates directory into the client's website root directory.

3. Copy the file(s) from the dII directory into the client's WINNT/System32 or WINNT/System32/inetsvr directory.

2. Install the efavorites dll

If the client is Using Microsoft Transaction Server:

Run Component Services

Expand Component Services to My Computer /Com+ Applications

Select COM+ Applications

Right-click COM+ Applications, select New/Application

Create an empty application

Name it Efavorites; select Server application

Select Interactive user

Finish

Expand Efavorites/Components

Select Components

Right click on Components

Select New/Component

Select Install new component

Select the dll from the directory in which it is placed.

Finish

If the client is Not Using Microsoft Transaction Server:

Open a cmd window.

Go to the directory in which the dll is placed, e.g.,

>CD WINNT/System32/inetsvr

Register the dll using RegSvr32, e.g.

>RegSvr32 efavoritesVB.dll

3. Set Up the efavorites Site Parameters File

Efavorites requires that the client set five variables on any web page that calls efavorites tags. These variables are set in a file named SiteParameters.asp, which will be in the root directory of the client's website. The variables set in this file are listed below.

| Variable | Remarks |
|---|---|
| ef_server_url | efavorites will provide the value for this variable |
| ef_client_id | efavorites will provide the value for this variable |
| ef_machine_id | This is a unique identifier that identifies an |
| | anonymous user. It should be persistent. |
| | By default it is set as a cookie. |
| ef_member_id | This is the unique identifier that you use to identify a |
| | user who has registered with you. It should |
| | be persistent. By default it is set as a cookie. |
| ef_session_id | This is a unique identifier that you use to identify a |
| | given shopping session. By |
| | default it is set as a cookie. |

4. Adapt the ASP Template Pages to Your Site

Efavorites provides complete ASP templates for direct integration in the client's web site. These pages already include the necessary tags for enabling efavorites functionality. The client may rename or edit them to change their look and feel, to enable or disable certain functionality, or to add links to other pages on their site. The client may also cut code from the template pages and paste it into existing pages on their website.

### Steps

1 . Add the efavorite “Resource Location” SSI statement to ASP Pages

By default, efavorites templates look for cascading style sheets and JavaScript source files that reside in the efav directory on your website. The locations of these files are defined in an ASP include file named ResourceLocations.asp, which will be in the efav/AspIncludes directory.

This file must be included the ASP files via an SSI statement, preferably in the <HEAD>section of the client's document. The format of the SSI statement is

### <!--#include file=“../efav/AspIncludes/ResourceLocations.asp”-->

2. Add an efavorites “Function File” SSI statement to ASP Pages

Efavorites content is dynamically published into the client's web pages via Visual Basic function calls known as “tags”. These functions are defined in a series of VB include files. These files must be integrated into the ASP files via SSI statements prior to calling any efavorites tags. The names of these function files are provided in Appendix A. The format of the SSI statement is

### <!--#include file=“../efav/AspIncludes/ReviewerFunctions.asp”-->

3. Add efavorites VB code to ASP pages where required

In a few cases, a few lines of Visual Basic code must be added to the ASP page. The examples listed below will explain those cases.

4. Add efavorites Content Tags in the HTML sections of ASP pages Content tags are inserted into the client's HTML pages wherever they want to include efavorites content. They are typically inserted into table cells. Here is an example of a set of efavorites tags used on a member's home page.

<TABLE>

<tr><td><%=getMyRecommendations(efav_disp) %></td></tr>

<tr><td><%=getMyWishList(efav_disp) %></td></tr>

</table>

Some of these tags require arguments. The arguments are described below.

### Template Pages

Efavorites provides ASP page templates for integration in the client's web site. These are: 1) ef_mypage.asp (also referred to as Member Home Page); 2) ef_otherspage.asp; 3) ef_searchresultspage.asp; 4) ef_groupspage.asp; 5) ef_expertspage.asp; 6) ef_experstlispaget.asp; and 7) ef_groupspage.asp.

These pages already include the necessary tags for enabling efavorites functionality. They may be edited to change their look and feel, to enable or disable certain functionality, or to add links to other pages on the client's site. The efavorites tags on these pages should not require modification.

The names of these files may be changed. The fully qualified URL's to these and other pages must be provided to efavorites for inclusion in the client profile.

The client provides links to ef_mypage.asp (the member's home page) on their web site. They do not have to provide links to the other pages. Following dynamically generated links and using efavorites functionality will automatically bring up the other pages.

Efavorites also provides several ASP templates that show the client how to add efavorites content tags to their existing pages. These are: 1) DetailPage.asp; 2) SignupForm.asp and SignupDone.asp; 3) LoginForm.asp and LoginDone.asp; and 4) Cart.asp.

### Content Tag Integration

The efavorites content tags are inserted into the client's HTML pages wherever they want to include efavorites content. They are typically inserted into table cells.

### Custom Tags Requiring Partner Integration

These tags are added to existing web pages. Examples are provided in the efavorites-supplied Product, Signup, Login and Cart templates.

Each tag is listed on the page it typically appears. Following the tag name is the list of parameter values the tag requires.

| Tag: Object | Remarks |
|---|---|
| Member Registration Page: | |
| SignUpFunctions | |
| sendMemberInfo | Registers a new member with |
| member_id | efavorites, or identifies an |
| e_mail | existing member. This tag is used |
| first_name | when “piggybacking” efavorites |
| last_name | registration on an existing |
| | registration service. |
| | Efavorites specific Login Template |
| | pages are also available. |
| Detail Page: | |
| ProductFunctions | |
| setProductInfo | Sets product data variables. |
| product_name | Must be called prior to |
| product_number | calling any product-related tags |
| client_category_num | or to adding a product to the |
| product_url | shopping cart. |
| getProductRecommendations | Publishes all the recommendations |
| | written about this item. |
| getRelatedProductSelections | Publishes links to products that |
| | are most commonly selected |
| | with this product. |
| getRelatedProductRecommendations | Publishes links to items that |
| | are related to this one by |
| | recommendations. |
| getForwardLink | Places a link on the page that user |
| | may use to send an e-mail |
| | containing a link to the item |
| | and their comments. |
| getAddRecLink | Places a link on the page that user |
| | may use to write their |
| | recommendations. |
| getAdd WishLinkPlaces | a link on the page that user may |
| | use to add an item to their wish |
| | list. |
| Shopping Cart Page: | |
| ProductFunctions | |
| sendShoppingCartInfo | Registers a product selection with |
| qty | efavorites. |
| | setProductInfo must be called first. |
| Other | |
| ReviewerFunctions | |
| getFeaturedExpert | Publishes information and picture |
| feature_number | of a client-selected Expert on the |
| | page. |
| | Typical locations are Site |
| | Home Page, MyPage, |
| | and/or OthersPage |
| getFeaturedMember | Publishes information and picture |
| feature_number | of a client-selected member on |
| | the page. |

### Tags in efavorites-Supplied Template Pages

These tags are already implemented in the efavorites-supplied template pages. The client can customize these pages by adding, deleting, or changing the order of tags.

| Tag | Remarks |
|---|---|
| Member Home Page | |
| MyPageFunctions | |
| getWhyUseEfavorites | Publishes information about |
| | recommendations and a link to your |
| | signup page. |
| getMyProfile | Publishes the users bio and a link to edit |
| | it. |
| getMyActivity | Publishes member activity information, |
| | including reviewer rank, number of |
| | recommendations, and number of |
| | helpful votes received. |
| getMyRecommendations | Publishes the recommendations this |
| | member has written. |
| getMyWishList | Publishes the products this member has |
| | added to his/her wish list. |
| getMyFavPeople | Publishes a list of people this member |
| | has chosen as a favorite person. |
| getMyGroups | Publishes a list of the groups that a |
| | member has joined. |
| getLotteryLink | Places a link on the page that the user |
| | may use to enter a lottery. |
| getMyRelatedSelections | Publishes a list of product selections |
| | made by people who selected the same |
| | products the user has selected. |
| getMyRelatedRecommendations | Publishes a list of recommendations |
| | made by people who recommended the |
| | same products the user has |
| | recommended. |
| Other Member's Page | |
| OthersFunctions | |
| getOthersName | Publishes this member's first and last |
| member_id | name. |
| getOthersRecommendations | Publishes the recommendations this |
| member_id | member has written. |
| getOthersWishList | Publishes the products this member has |
| member_id | added to his/her wish list. |
| getOthersProfile | |
| member_id | Publishes this member's bio and a link |
| | to add this person as a favorite person. |
| getOthersActivity | Publishes member activity information, |
| member_id | including reviewer rank, number of |
| | recommendations, and number of |
| | helpful votes received. |
| getOthersFavPeople | Publishes a list of people this member |
| member_id | has chosen as a favorite person. |
| People Search Page: | |
| SearchFunctions | |
| getSearchForm | Publishes a form that allows searching |
| | for other members by name or email |
| | address. |
| getSearchResults | Publishes the results of a people search. |
| searchkey | |
| searchstring | |
| Groups Page: | |
| GroupsFunctions | |
| getGroupRecommendations | Publishes a list of products most |
| group_id | commonly recommended by this group. |
| group_name | |
| Experts Page: | |
| ExpertsFunctions | |
| getExpertsProfile | Publishes a list of products most |
| member_id | commonly recommended by this group. |
| getExpertsListBox | Publishes a list of all site experts and |
| | links to their experts pages. |

Example embodiments of the present invention have now been described in accordance with the above advantages. It will be appreciated that these examples are merely illustrative of the invention. Many variations and modifications will be apparent to those skilled in the art.

### Appendix A: Variables Used In Content Tags

This is a list of the variables (arguments) that are referenced in efavorites include files and tags.

| Variable | Description | Remarks |
|---|---|---|
| client_category_n | Category ID for the product | |
| um | | |
| ef_client_id | Your unique ID number | Supplied by efavorites. |
| ef_machine_id | Unique ID to identify an | |
| | anonymous user. | |
| ef_member_id | Your unique ID for a registered | |
| | user. | |
| ef_searchkey | efavorites people search variable | Sent from efavorites |
| | | pages |
| ef_searchstring | efavorites people search variable | Sent from efavorites |
| | | pages |
| ef_server_url | URL for the efavorites server | Supplied by efavorites. |
| | that will be providing content to | |
| | your website | |
| ef_session_id | Unique ID to identify all the | |
| | products selected within a single | |
| | shopping cart. | |
| efav_display | efavorites display variable | Sent from efavorites |
| | | pages |
| feature | Alphanumeric ID for a featured | Feature info must be set |
| | reviewer. | up via the efavorites |
| | | Admin Tool. |
| group_id | efavorites group variable | Sent from efavorites |
| | | pages |
| group_name | efavorites group variable | Sent from efavorites |
| | | pages |
| member_email | Member's email address | |
| member_first_name | Member's first name | |
| member_id | efavorites unique ID for a | Sent from efavorites |
| | member | pages |
| member_last_name | Member's first name | |
| product_name | Product name | |
| product_number | Product number, as used to | |
| | identify the product at your site | |
| product_qty | Quantity of product put into the | |
| | shopping cart | |
| product_std_num | SKU or other industry standard | |
| | ID used to identify the product | |
| product_url | ID for the product, which when | |
| | combined with the | |
| | product_base_url defined in your | |
| | Client Profile, forms a fully | |
| | qualified URL for a product | |
| | detail page | |
| route | Flag indicating the page, if any, | Template pages show |
| | to which user should be | how the route flag is |
| | redirected after an action. Valid | used. |
| | route values and redirection | |
| | pages are: | |
| | “mypage” —member's home | |
| | page | |
| | “others” —other's home page | |
| | “experts” —expert's home page | |
| | “product” —product detail page | |

### Client Profile Data

Efavorites sets up a client profile for the client in the efavorites database that includes the following data. This profile is queried by efavorites applications.

client_homepg_url
URL of your site home page.
client_join_url
URL of your member signup/login page.
member_homepg_url
URL of your efavorites member home page.
others_homepg_url
URL of your efavorites other's home page.
search_results_url
URL of your efavorites people search results page.
groups_url
URL of your efavorites groups page.
product_base_url
Your product base URL. This is the URL that, when combined with an
individual “product url,” calls up a product detail page.
lottery_partner_url
URL to which to direct members to enter your lottery or other signup
enticement.
experts_url
URL of your efavorites expert's home page.
experts_list_url
URL of your efavorites experts list page.
forward_email_body_header
Standard text displayed at top of forwarded recommendations.
forward_email_body_footer
Standard text displayed at bottom of forwarded wish lists.
forward_wishlist_header
Standard text displayed above wish list link in forwarded wish lists.
forward_wishlist_footer
Standard text displayed below wish list link in forwarded wish lists.
return_email_address
Return address for emailing forgotten passwords. Only used if using
efavorites-supplied signup process.
client fav_num
Number of reviews and wishlist items initially displayed on member home
pages and product detail pages. Default is 5.
active_reviewer_period
Days for which a reviewer is considered “active” after adding or editing a
recommendation. Default is 30.
new_review_period
Days for which a review is flagged as “new.” Default is 14.9

What is claimed is:

1. A method for dynamically creating and providing customized content for a web page at a site on a network, comprising:
receiving a request from the network site for populating information for the web page;
identifying network site specific data for the populating information from a repository;
retrieving the identified network site specific data from the repository; and
transmitting the network site specific data to the network site for formatting and incorporation into the web page.

2. The method of claim 1 wherein the network is the Internet.

3. The method of claim 1, wherein the request is transmitted using lightweight tags embedded in the web page.

4. The method of claim 1, wherein the request from the network site is received at a server.

5. The method of claim 4, wherein software at the server identifies the network site specific data for populating information.

6. The method of claim 1, wherein identifying network site specific data includes collecting and collating data.

7. The method of claim 4, wherein the server transmits the network site specific data to the network site.

8. The method of claim 1, wherein the network site specific data is retrieved using a servlet.

9. The method of claim 8, wherein the servlet is a Java servlet.

10. The method of claim 1, wherein the repository comprises a database.

11. The method of claim 1, wherein the repository comprises a relational database.

12. The method of claim 1, wherein formatting and incorporation into the web page includes:
dynamically populating multiple reserved areas of the web page.

13. The method of claim 12, wherein the multiple reserved areas of the web page are dynamically populated using HyperText Marking Language code.

14. The method of claim 1, wherein the network site specific data includes relevance information, and wherein the network site specific data is formatted and incorporated into the web page at a publishing location on the web page, the publishing location being based on the relevance information.

15. A system for dynamically creating and providing customized content for a web page, comprising:
a network;
a site coupled to the a network; and
a server coupled to the network;
wherein a request is received from the network site for populating information for the web page;
wherein network site specific data is identified for the populating information from a repository;
wherein the identified network site specific data is retrieved from the repository; and
wherein the network site specific data is transmitted to the network site for formatting and incorporation into the web page.

16. The system of claim 15, wherein the network is the Internet.

17. The system of claim 15, wherein the server comprises one selected from a group consisting of a personal computer, a minicomputer, a microcomputer, and a main frame computer.

18. A system for dynamically creating and providing customized content for a web page at a site on a network, comprising:
means for receiving a request from the network site for populating information for the web page;
means for identifying network site specific data for the populating information from a repository;
means for retrieving the identified network site specific data from the repository; and
means for transmitting the network site specific data to the network site for formatting and incorporation into the web page.
